(19) United States
(12) Patent Application Publication
(10) Pub. No.: US 2010/0240532 A1
(43) Pub. Date: Sep. 23, 2010

(54) METHOD FOR PRODUCING A SORBENT BASED ON A METHYL-SILICIC ACID HYDROGEL

(76) Inventors: Yuriy Tolcheyev, Kiev (UA); Olfksandr Chygyryk, Kiev (UA); Volodymyr Semenov, Kiev (UA)

Correspondence Address: WEINER & BURT, P.C., 635 N US-23, POB 186, HARRISVILLE, MI, 48740, US

(21) Appl. No.: 12/438,135

(22) PCT Filed: Oct. 30, 2006
(86) PCT No.: PCT/UA2006/000057

§ 371 Date: Feb. 19, 2009

(30) Foreign Application Priority Data
Sep. 20, 2006 (UA) A 2006 10083

(51) Int. Cl. B01J 20/22

(52) U.S. Cl. 502/401

(57) ABSTRACT

The inventive method for producing a sorbent consists in adding a strong acid solution to a methylsiliconate sodium (or potassium) solution for obtaining a product, which after being stabilised, is ground and activated by adding a strong acid to the solution, is washed out by water until a neutral reaction is attained in such a way that a product, the pore space of which is equal to or greater that 0.8 cm³/g is obtained, wherein said product exhibits adsorption properties with respect to mean- and high-molecular agents and can contain chemical and/or biological additives. The thus obtained product has a general formula: {(CH₃SiO_{1.5})nH₂O}[k₁ . . . Kₘ], wherein ki is a mass ratio (mass %) for chemical additives (m≧2) or a qualitative characteristic for the content of biological additives; xerogel is produced at n=0; gel form is produced at n=30-46; past form is produced at n=54-62; suspension form is produced at n=63-495.

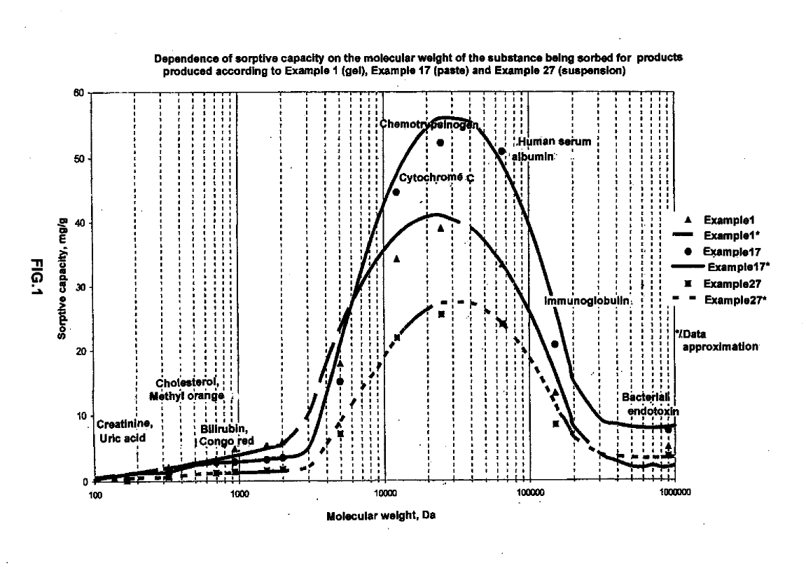

### TECHNICAL FIELD

The method for producing a sorbent based on a methylsilicic acid hydrogel relates to the field of pharmaceutical chemistry, particularly to a method of preparing new chemical compounds, namely, polymethylsiloxanes/methylsilicic acid hydrogels. The product produced by this method can find use in various domains of medicine and veterinary science as a sorbent capable of selective excretion of toxic substances of high molecular weight (10,000-500,000 Dalton and more.

### BACKGROUND ART

The novel product is active in binding high-molecular substances, which include the microbial endotoxin, specific toxins of pathogenic bacteria and a large number of regulatory proteins.

Toxins bounded by a sorbent become inactive and is excreted together with the sorbent by natural ways. Thereby, a toxic syndrome is eliminated and an antigenic load on immunocompetent cells is reduced to contribute to compensation of immunodeficiency (secondary), which arises as a result of the development of a pathologic process.

Adsorption of a series of regulatory proteins (enzymes, cytokines immunoglobulins) by the novel product accounts for distant effects of enterosorption, i.e., normalization of viscera functions, hematopoietic and immune systems, thereby diminishing severity of a disease, preventing development of multiple organ failures and critical states.

Known in the art is a method for producing “ENTEROSGEL-SUPER” sorbent or a methylsilicic acid hydrogel (RU 2111979, C1). Features common to this invention and the prior art method are the following steps: adding a solution of a strong acid to a solution of sodium methylsiliconate or potassium methylsiliconate until a product is formed, then holding, comminuting, activating the product by adding a diluted solution of a strong acid and washing the product to a neutral reaction.

Among the disadvantages of the prior art method can be mentioned the fact that the sorbent produced by the prior art method has pores mainly of a medium diameter (mesopores), so it is correspondingly capable of sorption of only medium-molecular metabolites (of molecular weight between 100 and 1000 Dalton); (b) the sorbent exhibits these sorptive properties in the form of a gel and without additives.

Known in the art is a method for producing a powder product (xerogel) by drying polymethylsiloxane (SU 911290, C1) with a surface area of 90 to 100 m²/g, a pore radius of 15 to 20 Å, and a “sensitivity” to small molecules (ethyl alcohol vapor). This method is not only silent about sorptive characteristics of the xerogel produced thereby, but there is no suggestion that the product capable of selective excretion of toxic substances of high molecular weight.

In a prior art method for producing a liposome formulation (RU 210469, C1), a suspension of an enterosgel on the basis of polymethylsiloxane in distilled water is used as additive for dispersing lipids. A disadvantage of this method is also a limited adsorption spectrum of the enterosgel (medium-size molecules). Also, because the suspension was prepared ex tempore with the view of dispersing lipids, the knowledge of this method cannot be obvious for those skilled the pertinent art in preparing a stable suspension product exhibiting sorptive properties and capable of selective excretion of toxic substances of high molecular weight.

It is known, for example, from patent application RU 2005115523, that additives introduced into the compositions of various enterosorbents give new properties to end products. Such additives, however, involve some disadvantages, such as worsening of sorptive activity of the sorbents and a significant limitation of medical applications of such sorbents. The lack of production of sorbents on the basis of polymethylsiloxane with additives is most likely to be due these disadvantages.

The above-mentioned disadvantages of the prior-art methods essentially limit a possibility to apply the products produced by these methods as adsorbents in medicine and veterinary practice.

### DISCLOSURE OF THE INVENTION

The present invention aims to provide a method for producing a sorbent based on a methylsilicic acid hydrogel through the use of a certain concentration of sodium methylsiliconate or potassium methylsiliconate and various proportions of the product and water molecules as well as weight percentages of chemical and/or biological additives to ensure obtaining an end product featuring a high sorptive capacity with respect to high-molecular substances, among which are exo- and endotoxins, including a microbial endotoxin, immunoglobulins and regulatory proteins.

The technical result of the present invention is the provision of a product of a high sorptive capacity with respect to high-molecular substances. The product according to the invention has a spatial framework and a large surface area (up to 1000 m²/g) that condition emergence of multiple zones of interaction between hydroxil groups of the sorbent and active groups of large molecules (Van der Waals and other bonds) and lead to binding micromolecular substances with the sorbent by other coprecipitation mechanism (or sorption into the body of a solution). This mechanism has been discovered owing to novel and unexpectedly found process conditions and to a compromise between the end product and water molecules with the result that introduction of additives without impairment of sorptive properties becomes possible. It has been due to the novel coprecipitation mechanism realized in the claimed method that end products of various stable forms became possible, the forms being powder (xerogel), gel, paste or suspension, and in combination with various additives without any impairment of sorptive properties. The sorbent produced by the method of the invention is an effective detoxicant in all of its final forms and it mediately optimizes viscera functions and body systems to enable patients to avoid complications and to make a fast recovery.

To the accomplishment of the foregoing object, there is provided a method for producing a sorbent based on a methylsilicic acid hydrogel of the general formula

{(CH₃SiO_{1.5})_{∞}.nH₂O},

comprising the following steps: adding a solution of a strong acid to a solution of sodium methylsiliconate or potassium methylsiliconate until a product is formed, then holding, comminuting, activating the product by adding a diluted solution of a strong acid and washing the product to a neutral reaction, wherein, according to the invention, the solution of sodium methylsiliconate or potassium methylsiliconate is at a concentration of 2.35-2.95 mol/L and, by varying the multiplier n, the sorbent is obtained in a powdered, gel, paste-like form or as a suspension and exhibiting selective adsorption properties with respect to high-molecular substances with a molecular weight of 10,000-500,000 Dalton and more.

In one of preferable embodiments of the invention the introduction of additives into the sorbent has been made possible without impairment of sorptive properties to obtain a product of the general formula

{(CH₃SiO_{1.5})_{∞}.nH₂O}.[k₁ . . . kₘ],

wherein kᵢ is percentage (weight %) of chemical additives (m≧2) or an amount of biological additives;

at n=0, a product is obtained having a powdered form (xerogel) with additives (at kᵢ≠0) or without additives (at kᵢ=0);

at n=30-46, the product has a gel-like form;

at n=47-62, a product is obtained having a paste-like form with additives (at kᵢ≠0) or without additives (at kᵢ=0);

at n=63-495, a product is obtained having a form of a suspension with additives (at kᵢ≠0) or without additives (at kᵢ=0).

According to the invention, preferred in selecting additives is a mixture of sweeteners at a concentration of 0.5 weight

preservatives at a concentration of 0.5 weight %,

copper sulfate at a concentration of 1.0 weight %,

zinc sulfate at a concentration of 1.0 weight %,

eubiotics and/or probiotics are further added to the product at a concentration of 10⁶-10¹² CFU per gram of the product.

The invention will now be explained by specific embodiments thereof and by a drawing FIGURE graphically representing the dependence of a sorptive capacity from the molecular weight of a sorbate for products produced according to alternative ways of carrying out the method.

### BEST MODE FOR CARRYING OUT THE INVENTION

The method of the invention is carried out as follows.

A solution of sodium methylsiliconate or potassium methylsiliconate at a concentration of 2.35-2.95 mol/L is subjected to polycondensation by adding a solution of a strong acid (hydrochloric or sulfuric acid) until a hydrogel is formed. The hydrogel is held for 30-90 minutes until ripe, then comminuted, and activated under the action of a diluted solution of a strong acid at a concentration of 0.04-0.15 gram equivalents per liter and subsequently washing the product to a neutral reaction. Chemical or biological additives are further added. With changing the number of water molecules and the weight proportion of the chemical or biological additive, the obtained product may be in the form of a suspension or paste (following dispersing and subsequent homogenizing of a mixture), or the form of a powder (following drying of the product to constant mass), specifically:

at n=0, a product is obtained having a powdered form (xerogel) with additives (at kᵢ≠0) or without additives (at kᵢ=0);

at n=30-46, the product has a gel-like form;

at n=45-62, a product is obtained having a paste-like form with additives (at kᵢ≠0) or without additives (at kᵢ=0);

at n=63-495, a product is obtained having a form of a suspension with additives (at kᵢ≠0) or without additives (at kᵢ=0).

### Example 1

### Method for Producing a Product

A solution of a strong acid is added to 100 mL of a solution of sodium methylsiliconate at the concentration of 2.35 mol/L until a hydrogel is formed. The hydrogel is held for some time until ripe, then comminuted, and the solution of the same strong acid, but diluted, is pored over the hydrogel. The resulting hydrogel is washed with water until it shows a negative reaction toward anions and has neutral acidity values.

### Examples 2-13

The hydrogel of methylsilicic acid is produced as in Example 1 and sodium methylsiliconate at a concentration of 2.40-2.95 mol/L is used as a starting reactant.

### Examples 14-15

The hydrogel of methylsilicic acid is produced as in Examples 1-14 and solutions of sodium methylsiliconate and of a strong acid (Example 15), and a mixture of solutions of sodium methylsiliconate and potassium methylsiliconate, and a strong acid (Example 16) are used as starting reactants.

### Example 16

### Producing a Paste-Like Product

Water in the amount of 30 g is added to 70 g of the methylsilicic acid hydrogel prepared as in Examples 1-15, and the hydrogel is dispersed and then homogenized until a paste-like product is formed.

### Examples 17-25

### Producing a Paste-Like Product with Various Proportions of the Methylsilicic Acid Hydrogel and Water

The methylsilicic acid hydrogel and water are mixed as in Example 16 taking 90 g methylsilicic acid hydrogel and 10 g water (Example 17), 85 g methylsilicic acid hydrogel and 15 g water (Example 18), 80 g methylsilicic acid hydrogel and 20 g water (Example 19), 75 g methylsilicic acid hydrogel and 25 g water (Example 20), 65 g methylsilicic acid hydrogel and 35 g water (Example 21), 60 g methylsilicic acid hydrogel and 40 g water (Example 22), 55 g methylsilicic acid hydrogel and 45 g water (Example 23), 50 g methylsilicic acid hydrogel and 50 g water (Example 24), 45 g methylsilicic acid hydrogel and 55 g water (Example 25).

### Example 26

### Producing a Suspension Form of the Product

Water in the amount of 70 g is added to 30 g of the methylsilicic acid hydrogel prepared as in Examples 1-15, and the hydrogel is dispersed and then homogenized until a paste-like product is formed.

### Examples 27-32

### Producing a Suspension Form of the Product with Various Proportions of the Methylsilicic Acid Hydrogel and Water

The methylsilicic acid hydrogel and water are mixed as in Example 26 taking 40 g methylsilicic acid hydrogel and 60 g water (Example 27), 35 g methylsilicic acid hydrogel and 65 g water (Example 28), 25 g methylsilicic acid hydrogel and 75 g water (Example 29), 20 g methylsilicic acid hydrogel and 80 g water (Example 30), 15 g methylsilicic add hydrogel and 85 g water (Example 31), 10 g methylsilicic acid hydrogel and 90 g water (Example 32).

### Example 33

### Producing the Product with Sweeteners

A mixture of sweeteners consisting of sodium cyclamate and saccharin is further added to 100 g of the product produced as in Examples 16-32. The amount of sweeteners in the end product is 0.2 weight %.

### Example 34

### Producing the Product with Sucralose as a Sweetener

The product is produced as in Example 33 and sucralose is used as a sweetener. The amount of sucralose in the end product is 0.1 weight %.

### Example 35

### Producing the Product with a Chemical Additive, which is Sodium Benzoate as a Preservative

Sodium benzoate as a preservative is further added to 100 g of the product produced as in Examples 16-34. The amount of sodium benzoate in the end product is 0.5 weight %.

### Examples 36-39

### Producing the Product with Various Preservatives

The product is produced as in Example 35 and citric acid is used as a preservative, the content of which in the end product is 0.5 weight % (Example 36), tartaric acid is used as a preservative, the content of which in the end product is 0.5 weight % (Example 37), succinic acid is used as a preservative, the content of which in the end product is 0.5 weight % (Example 38), benzalkonium chloride is used as a preservative, the content of which in the end product is 0.5 weight % (Example 39).

### Example 40

### Producing a Powdery Product

The product in the amount of 100 g prepared as in Examples 1-15 is dried at 125±5° C. to constant mass. A xerogel in the amounts of 7.5 g to 11.0 g is produced.

### Example 41

### A Powdery Product Containing Copper Sulfate

The product is prepared as in Example 40 with copper sulfate previously added in the amount that is necessary for the copper sulfate content of 0.7 weight % to be in the end product.

### Example 42

### A Powdery Product Containing Zinc Sulfate

The product is prepared as in Example 40 with zinc sulfate previously added in the amount that is necessary for the zinc sulfate content of 0.7 weight % to be in the end product.

### Example 43

### The Product with Biological Additives, which are Eubiotics

The product prepared as in Examples 16-25 is taken in the amount such that it may comprise 10 g of the dry residue and this amount is mixed with freeze-dried eubiotic cultures of Bacillus subtilis and Bacillus licheniformis. The amount of eubiotics is 10⁶-10¹² CFU per gram of the end product.

The present invention provides for obtaining a product of a high sorptive capacity with respect to high-molecular substances. The method also makes sure obtaining of various forms of the end product, namely, paste-like, powdery forms or in the form of a suspension as well as in combinations with various additives.

Tables 1-3 show the characteristics of the products produced as described in the foregoing examples.

As seen in Table 1, sorptive capacities with respect to high-molecular substances of the end products in the form of gels, pastes and suspensions are related as 1.0:1.5:2.0 respectively, to prove their discreteness, specificity and stability.

Some examples are represented in graphical form in the drawing FIGURE.

TABLE 1
Properties of the products obtained according to Examples 1-32 (gel, paste, and suspension)

| | | | | Sorptive | | |
|---|---|---|---|---|---|---|
| | | | Sorptive | capacity for | | |
| | | | capacity for | human serum | | |
| | | Silicon | Congo red, | albumin, | Ratio of | |
| Example | Dry residue content, | content, | mg/g | mg/g | sorptive | |
| No. | weight % | weight % | (α < 0.01) | (α < 0.01) | capacities | Formula |
| 1 | 2 | 3 | 4 | 5 | 6 | 7 |
| 1.* | 11.0 | 4.75 | 3.3 | 33.4 | 10.1 | {CH₃SiO_{1.5}}•30H₂O |
| 2. | 10.4 | 4.48 | 3.3 | 33.1 | 10.0 | {CH₃SiO_{1.5}}•32H₂O |
| 3. | 9.9 | 4.25 | 3.1 | 31.7 | 10.2 | {CH₃SiO_{1.5}}•34H₂O |
| 4. | 9.4 | 4.03 | 3.0 | 30.2 | 10.0 | {CH₃SiO_{1.5}}•36H₂O |
| 5. | 8.9 | 3.84 | 2.8 | 28.2 | 10.1 | {CH₃SiO_{1.5}}•38H₂O |
| 6. | 8.5 | 3.66 | 2.7 | 27.5 | 10.2 | {CH₃SiO_{1.5}}•40H₂O |
| 7. | 8.2 | 3.50 | 2.6 | 26.6 | 10.2 | {CH₃SiO_{1.5}}•42H₂O |
| 8. | 7.8 | 3.36 | 2.5 | 25.3 | 10.1 | {CH₃SiO_{1.5}}•44H₂O |
| 9. | 7.5 | 3.22 | 2.4 | 24.4 | 10.2 | {CH₃SiO_{1.5}}•46H₂O |
| 10. | 9.6 | 4.14 | 3.0 | 30.8 | 10.3 | {CH₃SiO_{1.5}}•35H₂O |
| 11. | 9.2 | 3.93 | 2.9 | 30.0 | 10.4 | {CH₃SiO_{1.5}}•37H₂O |
| 12. | 7.6 | 3.29 | 2.4 | 24.7 | 10.3 | {CH₃SiO_{1.5}}•45H₂O |
| 13. | 8.3 | 3.58 | 2.7 | 26.9 | 10.0 | {CH₃SiO_{1.5}}•41H₂O |
| 14. | 10.1 | 4.36 | 3.2 | 32.3 | 10.1 | {CH₃SiO_{1.5}}•33H₂O |
| 15. | 8.0 | 3.43 | 2.6 | 26.0 | 10.0 | {CH₃SiO_{1.5}}•43H₂O |
| 16.* | 6.68 | 2.87 | 3.2 | 49.1 | 15.4 | {CH₃SiO_{1.5}}•52H₂O |
| 17. | 7.8 | 3.29 | 3.8 | 58.0 | 15.3 | {CH₃SiO_{1.5}}•45H₂O |
| 18. | 7.34 | 3.16 | 3.6 | 54.7 | 15.2 | {CH₃SiO_{1.5}}•47H₂O |
| 19. | 7.06 | 3.04 | 3.4 | 52.6 | 15.5 | {CH₃SiO_{1.5}}•49H₂O |
| 20. | 6.93 | 2.98 | 3.4 | 51.6 | 15.2 | {CH₃SiO_{1.5}}•50H₂O |
| 21. | 6.57 | 2.82 | 3.2 | 49.0 | 15.3 | {CH₃SiO_{1.5}}•53H₂O |
| 22. | 6.34 | 2.73 | 3.1 | 47.3 | 15.3 | {CH₃SiO_{1.5}}•55H₂O |
| 23. | 6.13 | 2.64 | 3.0 | 45.8 | 15.3 | {CH₃SiO_{1.5}}•57H₂O |
| 24. | 5.85 | 2.51 | 2.8 | 43.7 | 15.6 | {CH₃SiO_{1.5}}•60H₂O |
| 25. | 5.67 | 2.44 | 2.8 | 42.4 | 15.2 | {CH₃SiO_{1.5}}•62H₂O |
| 26.* | 3.74 | 1.61 | 1.2 | 24.0 | 20.0 | {CH₃SiO_{1.5}}•96H₂O |
| 27. | 5.58 | 2.40 | 1.8 | 36.1 | 20.1 | {CH₃SiO_{1.5}}•63H₂O |
| 28. | 4.73 | 2.03 | 1.5 | 30.6 | 20.4 | {CH₃SiO_{1.5}}•75H₂O |
| 29. | 2.68 | 1.15 | 0.85 | 17.5 | 20.6 | {CH₃SiO_{1.5}}•135H₂O |
| 30. | 1.99 | 0.86 | 0.65 | 13.1 | 20.2 | {CH₃SiO_{1.5}}•183H₂O |
| 31. | 1.35 | 0.58 | 0.45 | 9.0 | 20.0 | {CH₃SiO_{1.5}}•272H₂O |
| 32. | 0.75 | 0.32 | 0.25 | 5.1 | 20.4 | {CH₃SiO_{1.5}}•493H₂O |

*example represented in graphical form in the drawing figure.

TABLE 2
Properties of the products obtained according to Examples 33-39 and 43
(with various additives)

| | | | | Sorptive | | | |
|---|---|---|---|---|---|---|---|
| | | | | capacity for | | | |
| | | | Sorptive | human | | | |
| | | | capacity | serum | | | |
| | Dry | Silicon | for Congo | albumin, | Ratio of | | |
| | residue content, | content, | red, mg/g | mg/g | sorptive | | |
| Example No. | weight % | weight % | (α < 0.01) | (α < 0.01) | capacities | | Formula |
| 1 | 2 | 3 | 4 | 5 | 6 | Additive | 7 |
| 33. | 6.57 | 2.81 | 3.2 | 49 | 15.3 | sodium | {CH₃SiO_{1.5}}•53H₂O•[C₇H₅NO₃S]•[C₆H₁₂O₃SNa] |
| | | | | | | cyclamate | |
| | | | | | | and | |
| | | | | | | saccharin | |
| 34. | 6.34 | 2.72 | 3.1 | 47.1 | 15.2 | sucralose | {CH₃SiO_{1.5}}•55H₂O•[C₁₂H₁₉O₈Cl₃] |
| 35. | 5.85 | 2.50 | 2.8 | 43.5 | 15.5 | sodium | {CH₃SiO_{1.5}}•60H₂O•[C₇H₅O₂Na]• |
| | | | | | | benzoate | |
| 36. | 4.73 | 2.02 | 1.5 | 30.4 | 20.3 | citric acid | {CH₃SiO_{1.5}}•75H₂O•[C₆H₈O₇] |
| 37. | 3.74 | 1.60 | 0.84 | 17.4 | 20.7 | tartaric acid | {CH₃SiO_{1.5}}•96H₂O•[C₄H₆O₆] |
| 38. | 2.68 | 1.14 | 1.2 | 23.9 | 19.9 | succinic acid | {CH₃SiO_{1.5}}•135H₂O•[C₄H₆O₄] |
| 39. | 1.35 | 0.58 | 0.45 | 9.0 | 20.0 | benzalkonium | {CH₃SiO_{1.5}}•272H₂O•[C₂₁H₃₈ClN] |
| | | | | | | chloride | |
| 43. | 6.93 | 2.95 | 3.4 | 51.1 | 15.0 | Bacillus | {CH₃SiO_{1.5}}•50H₂O• |
| | | | | | | subtilis and | [Bacillus subtilis] |
| | | | | | | Bacillus | [Bacillus licheniformis] |
| | | | | | | licheniformis | |

TABLE 3
Properties of the products obtained according to Examples 40-42 (powder with various additives)

| | Dry residue | Silicon | Pore sorption | | | |
|---|---|---|---|---|---|---|
| | content, | content, | volume for | Surface | | |
| Example No. | weight % | weight % | hexane, cm³/g** | area, m²/g** | Additive | Formula |
| 41. | 100 | 43.00 | 1.10 | 900 | — | {CH₃SiO_{1.5}} |
| 42. | 100 | 42.70 | 1.05 | 850 | copper sulfate | {CH₃SiO_{1.5}}•[CuSO₄] |
| 43. | 100 | 42.68 | 1.03 | 850 | zinc sulfate | {CH₃SiO_{1.5}}•[ZnSO₄] |

**Determined by the BET (Brunauer-Emmett-Teller) method based on the multi-layer molecular adsorption model.

1. Method for producing a sorbent based on a methylsilicic acid hydrogel of the general formula
{(CH₃SiO_{1.5})_{∞}.nH₂O},
comprising: adding a solution of a strong acid to a solution of sodium methylsiliconate or potassium methylsiliconate until a product is formed, then holding, comminuting, activating the product by adding a diluted solution of a strong acid and washing the product to a neutral reaction, characterized in that the solution of sodium methylsiliconate or potassium methylsiliconate is at a concentration of 2.35-2.95 mol/L and, by varying the multiplier n, the sorbent is obtained in a powdered, gel, paste-like form or as a suspension and exhibiting selective adsorption properties with respect to high-molecular substances with a molecular weight of 10,000-500,000 Dalton and more.

2. The method of claim 1, characterized in that the obtained sorbent is mixed with additives to form an end product of the general formula
{(CH₃SiO_{1.5})_{∞}.nH₂O}.[k₁ . . . kₘ],
wherein kᵢ is percentage (weight %) of chemical additives (m≧2) or an amount of biological additives.

3. The method of claim 2, characterized in that a mixture of sweeteners at a concentration up to 0.5 weight % is used as the additives.

4. The method of claim 2, characterized in that preservatives at a concentration up to 0.5 weight % are used as the additives.

5. The method of claim 2, characterized in that copper sulfate at a concentration up to 1.0 weight % is used as the additive.

6. The method of claim 2, characterized in that zinc sulfate at a concentration up to 1.0 weight % is used as the additive.

7. The method of claim 2, characterized in that eubiotics and/or probiotics at a concentration of 10⁶-10¹² CFU per gram of the end product are used as the additives.
